(19) United States
(12) Patent Application Publication
(10) Pub. No.: US 2008/0301182 A1
(43) Pub. Date: Dec. 4, 2008

(54) Object-Based Real-Time Information Management Method and Apparatus

(75) Inventors: Xiaofeng Liu, Shanghai (CN); Jun Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,093

(22) PCT Filed: Nov. 1, 2006
(86) PCT No.: PCT/IB2006/054034

§ 371 Date: Apr. 30, 2008

(30) Foreign Application Priority Data
Nov. 3, 2005 (CN) 200510120047.2

(51) Int. Cl. G06F 17/30

(52) U.S. Cl. 707/103 R; 707/E17.005; 707/E17.055

(57) ABSTRACT

The present invention provides an object-based method and apparatus for management of real-time information. Said method includes the steps of obtaining an identification information of an object, said identification information including identity information of said object and the relevant information of an event of said object; receiving a real-time information, said real time information being associated with said event of said object; and labeling said real-time information according to said identification information. By means of the present invention, real-time information can be labeled according to object identification information, so not only the real-time information storage space is effectively saved, but the user's time for subsequently searching and editing the stored real-time information can also be saved.

### FIELD OF THE INVENTION

The present invention relates to an information management method and apparatus, in particular, to the object-based method and apparatus for management of real-time information such as video surveillance information.

### BACKGROUND OF THE INVENTION

Nowadays, video surveillance technology has been widely used in many fields. For example, places like supermarkets, banks or homes sometimes need to use the video surveillance system to monitor people or things, and to store the corresponding real-time video information for future examination.

Usually, the camera device used for video surveillance will be in the working state continuously, and the video contents shot are consecutively recorded in a storage server. In some cases, the user is not interested in the monitored scenes at all time, but he may only wants to monitor the scenes when a specific person or thing shows up, then the user could use object identification technology, such as RFID (Radio Frequency Identification) technology, to monitor specific object pertinently. For example, U.S. patent application No. 2004/0164858 “INTEGRATED RFID AND VIDEO TRACKING SYSTEM” which was laid open on Aug. 26, 2004 and invented by Yun-Ting Lin has disclosed a video monitoring system having the RFID object tracking function integrated therewith.

However, when using said technology to monitor a plurality of objects, since the time for each object to appear is not regular, while recording the real-time video information of these objects, each of the camera devices is usually used as a single unit to respectively record and store, then the user performs operations like searching and editing on said stored information, so as to obtain the relevant video information with respect to the time at which each object appears, respectively, in this way, the user has to spend a lot of time in operation. Particularly, when the periods of time at which a plurality objects appear overlap, a lot of storage space of the storage server will be taken so as to store an independent video information for the period of time at which each object appears, respectively.

Moreover, under some circumstances, the user needs to monitor the monitoring scenes at all periods of time, and needs to particularly monitor the scenes of the periods of time when a specific person or thing appears as well, then the user will not only need to store all the real-time video information, but also need to repetitively store the real-time video information with respect to the period of time at which each object appears, thus a lot of storage spaces of the storage server will be consumed.

Therefore, there is the need to provide an object-based real-time management method and apparatus for effectively managing real-time information like video surveillance information so as to save the storage space and the user's operation time.

### OBJECT AND SUMMARY OF THE INVENTION

The present invention provides an object-based real-time management method and apparatus which could effectively manage real-time information like video surveillance information.

A real-time management method according to the present invention, comprises the steps of obtaining an identification information of an object, said identification information includes the identity information of said object and the relevant information of an event of said object; receiving a real-time information, said real-time information is associated with said event of said object; labeling said real-time information according to said identification information.

A real-time management apparatus according to the present invention, comprises an object identification information receiving device for obtaining an identification information of an object, said identification information includes the identity information of said object and the relevant information of an event of said object; a real-time information receiving device for receiving a real-time information, said real-time information is associated with said event of said object; and a labeling device for labeling said real-time information according to said identification information.

In summary, the object-based real-time management method and apparatus provided by present invention could label the real-time information according to the object identification information and thus could effectively manage real-time information like video surveillance information. Therefore, it can not only effectively save the space for storing real-time information but also save the user's time for subsequently searching and editing the stored real-time information.

Other objects and attainments of the invention will become apparent and the invention will be understood full by referring to the following description and claims taken in conjunction with the accompanying drawings.

### BRIEF DESCRIPTION OF THE DRAWINGS

FIG. 1 is the schematic drawing of the structure of the video surveillance system according to one embodiment of the present invention.

FIG. 2 is the schematic drawing of the structure of the managing device of the video surveillance system according to one embodiment of the present invention.

FIG. 3 is a schematic drawing of labeling the video stream according to one embodiment of the present invention.

FIG. 4 is the flow chart of the managing method of the video surveillance system according to one embodiment of the present invention.

In all the above figures, the same signs indicate the same, similar or corresponding features or functions.

### DETAILED DESCRIPTION OF THE INVENTION

The preferred embodiments of the present invention will be described in detail with reference to the figures in the following text.

According to one embodiment of the present invention, the present invention will be described in detail with regard to the video surveillance system and the method of managing the video stream. Those skilled in the art should understand that the present invention can also be improved without deviating from the contents of the present invention and thus be applied to other fields, such as the monitoring and management of real-time information like audio information.

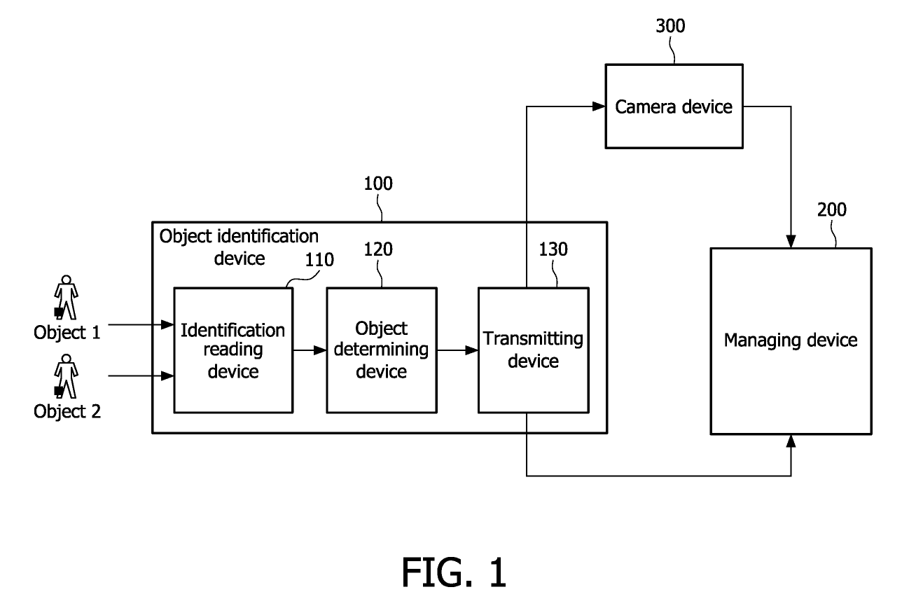

FIG. 1 is the schematic drawing of the structure of the video surveillance system according to one embodiment of the present invention. Said video surveillance system comprises an object identification device 100, a managing device 200 and a camera device 300.

Wherein said object identification device 100 comprises an identification reading device 110, an object determining device 120 and a transmitting device 130.

Said identification reading device 110 can be a RFID reader which sends radio frequency signal of a certain frequency through the antenna (not shown in the figure), when an object (person or object) with a RFID tag enters the identifiable range of the RFID reader, that is, when it enters the magnetic field range of the radio frequency signal transmitted by the RFID reader, the RFID tag generates induction current so as to obtain energy to transmit object identification information like code of itself to be read by the identification reading device 110 and then be decoded and sent to the object determining device 120 for object determination.

According to one embodiment of the present invention, the reading range of said identification reading device 110 and shooting ranging of said camera device 300 are substantially the same, so that the identification information of the objects that enter the shooting range could be read by said identification reading device 110.

Said object determining device 120 is used for comparing the received object identification information to a pre-set object identification information list to determine whether said object identification information is the object identification information in which the user is interested. Wherein said object identification information list is pre-set by the user to indicate the objects that the user wants to monitor.

If the result of determination made by the object determining device 120 is affirmative, that is, said object that enters the reading range of said identification reading device 110 is the user's interested one, the transmitting device 130 will transmit the identification information of said object to the managing device 200, so that the managing device 200 could store the corresponding video streams according to the identification information of said object. For instance, the following table 1 shows the format in which the transmitting device 130 transmits the object identification information.

TABLE 1

| | | | | | | | | | |
|---|---|---|---|---|---|---|---|---|---|
| Information | Number of | Object 1 | event | Object 2 | event | . . . | Object n | event | Information end |
| head | object | | | | | | | | |

Said information includes information head and information end, the number of objects included in said information, the identification information, such as ID number, corresponding to each object, and the corresponding event information, and said event information includes the status information of the object, such as “appear” or “leave”.

The transmitting device 130 can also be used to transmit an awakening information to the camera device 300. When a user's interested object appears, the transmitting device 130 transmits an awakening information to the camera device 300 to make it enter the working state from the dormant state.

According to one embodiment of the present invention, the managing device 200 is used to label and store the corresponding video streams according to the identification information of said object. The camera device 300 can include one or more pick-up heads for shooting a site of a certain range from a plurality of angles, or for respectively shooting places of different specific ranges, and it can convert the shot image sequence into a video stream that can be stored and played.

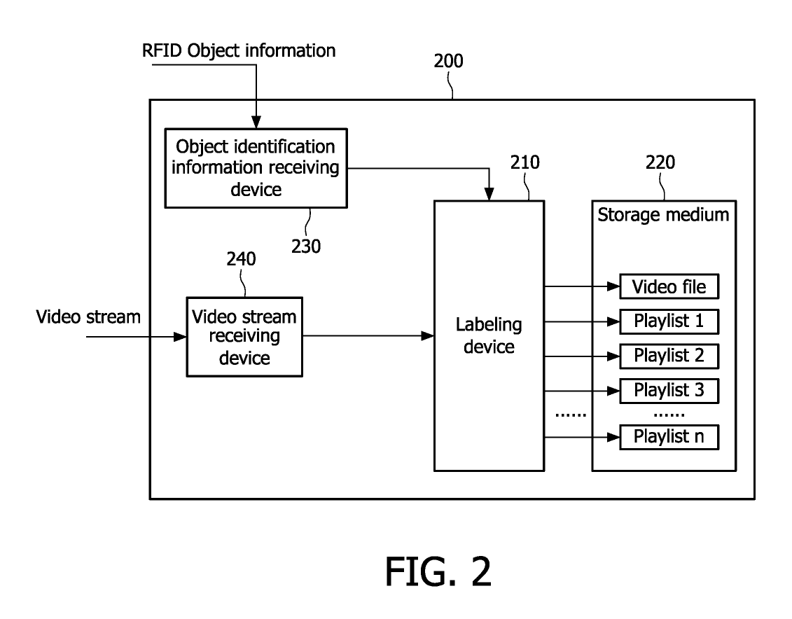

FIG. 2 is the schematic drawing of the structure of the management apparatus of the video surveillance system according to one embodiment of the present invention.

Said managing device 200 comprises a labeling device 210 for labeling the video streams generated by the camera device (not shown) according to the object identification information, so as to obtain a collection of video streams that corresponds to said object. According to different storage manners, said collection of video streams can include the collection of one or more video stream segments, or include the collection of one or more play intervals (included in one playlist).

Said labeling device 210 is used for labeling the received video streams according to the object identification information transmitted from the object identification device (as shown in FIG. 1). For example, the received object identification information is as shown in the following table 2.

TABLE 2

| | | | | |
|---|---|---|---|---|
| Information head | 1 | Object 1 | appear | Information end |

After receiving the information as shown in table 2, the labeling device 210 takes the synchronously received video stream as the start point, and adds a start label therein, said label can be a time information, such as 2005-10-20, 15:23:48, or the envelope information of a video stream. The end is when the labeling device 210 receives such information as shown in table 3.

TABLE 3

| | | | | |
|---|---|---|---|---|
| Information head | 1 | Object 1 | leave | Information end |

The information shown in table 3 indicates that object 1 left the area that could be monitored, the labeling device 210 still could perform corresponding operations on the received video stream so as to obtain a video stream segment that corresponds to the object. When the labeling device 210 receives information as shown in table 3, it takes the synchronously received video stream as the end point and adds the corresponding ending label thereto, for example, 2005-10-20, 15:45:29. Besides, the labeling device 210 records said beginning label information and ending label information in a playlist corresponding to object 1.

Said playlist can include one or a plurality of play intervals for each object, and each play interval represents the video recording of an object that continuously shows up once.

According to another embodiment of the present invention, there could also be the processing of real-time information of a plurality of camera devices at a plurality of monitoring areas. For instance, different RFID card readers and camera devices are placed at different monitoring areas, the labeling device 210 could associate the play intervals of the real-time video segments of the same object at different areas (corresponding to different camera devices), and record them into said playlist. The manner of association may be according to the time sequence or according to the number sequence of different camera devices.

According to another embodiment of the present invention, the labeling device 210 can also directly write said beginning label information and end label information into the compressed video stream. For example, after the managing device 200 receiving the video transmit stream from the monitoring device 300, the labeling device 210 can write the beginning label information and the end label information into the package header of the transmit stream of the corresponding time point, and associate said beginning label information and end label information with the corresponding object information, and record them to the playlist.

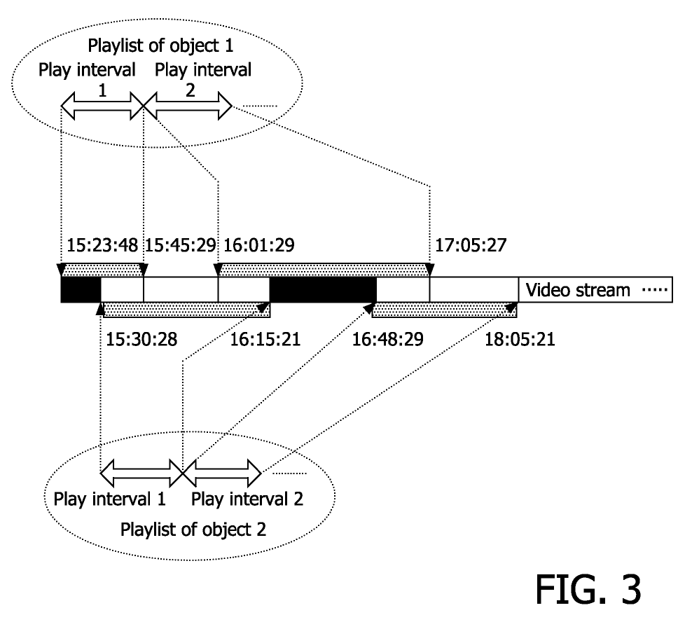

FIG. 3 is a schematic drawing of labeling the video stream according to one embodiment of the present invention.

In the present embodiment, the video stream includes playlists corresponding to object 1 and object 2, wherein the playlist of object 1 includes two play intervals which correspond to the interval video streams of object 1 appearing twice in the range that can be monitored. For example, the play interval 1 indicates the video stream of object 1 during the period of appearing on 2005-10-20 at 15:23:48, and leaving on 2005-10-20 at 16:45:29.

In the play interval 1 of object 1, i.e., 2005-10-20, 15:30:28, object 2 begins to appear in the range that could be monitored, and leaves on 2005-10-20, 16:15:21. Then, the play interval 1 of object 2 corresponds to the corresponding video stream of object 2 at this period of time.

For example, the playlist of object 1 in FIG. 3 can be realized in the following way by means of XML:

<Playlist >
<name> Collecton1 <\name>
<Stream_file_name> collection1.avi <\Stream_file_name>
<PlayItem>
<name> PlayItem1 <\name>
<clip>
<name> clip1 <\name>
<start time> 15:23:48<\start time>
<end time> 15:45:29<\end time>
<\clip>
<\PlayItem>
<PlayItem>
<name> PlayItem2 <\name>
<clip>
<name> clip2 <\name>
<start time> 16:01:29<\start time>
<end time> 17:05:27<\end time>
<\clip>
<\PlayItem>
......
<\Playlist>

By analogy, the playlist of object 2 in FIG. 3 can also be realized in the following way by means of XML:

<Playlist >
<name> Collecton2 <\name>
<Stream_file_name> collection2.avi <\Stream_file_name>
<PlayItem>
<name> PlayItem1 <\name>
<clip>
<name> clip1 <\name>
<start time> 15:30:28<\start time>
<end time> 16:15:21<\end time>
<\clip>
<\PlayItem>
<PlayItem>
<name> PlayItem2 <\name>
<clip>
<name> clip2 <\name>
<start time> 16:48:29<\start time>
<end time> 18:05:21<\end time>
<\clip>
<\PlayItem>
......
<\Playlist>

According to one embodiment of the present invention, when the user wants to see the video surveillance information in the condition when object 1 appears but object 2 does not appear (the black part of the video stream in the figure), he can establish a playlist as follows:

<Playlist >
<name> Collecton3 <\name>
<Stream_file_name> collection3.avi <\Stream_file_name>
<PlayItem>
<name> PlayItem1 <\name>
<clip>
<name> clip1 <\name>
<start time> 15:23:48<\start time>
<end time> 15:30:28<\end time>
<\clip>
<\PlayItem>
<PlayItem>
<name> PlayItem2 <\name>
<clip>
<name> clip2 <\name>
<start time> 16:15:21<\start time>
<end time> 16:48:29<\end time>
<\clip>
<\PlayItem>
......
<\Playlist>

As described in the above, by combining the beginning label information and end label information of different objects written into the compressed video stream by the labeling device 210, the user can set different conditions to see the corresponding video surveillance information, thus it facilitate the user to use.

Referring back to FIG. 2, according to one embodiment of the present invention, the managing device 200 further comprises a video stream receiving means 240 for receiving the video stream shot by the camera device; an object identification information receiving means 230 for receiving the object identification information transmitted by the object identification device, and for delivering said received object identification information to the labeling device 210, so that the labeling device 210 can correspondingly label the video stream according to the identification information of the objects; and a storage medium 220 for storing the video files received by the managing device 200 and the one or plurality of playlists (playlist 1 to playlist n) based on each object that are generated by the labeling device 210.

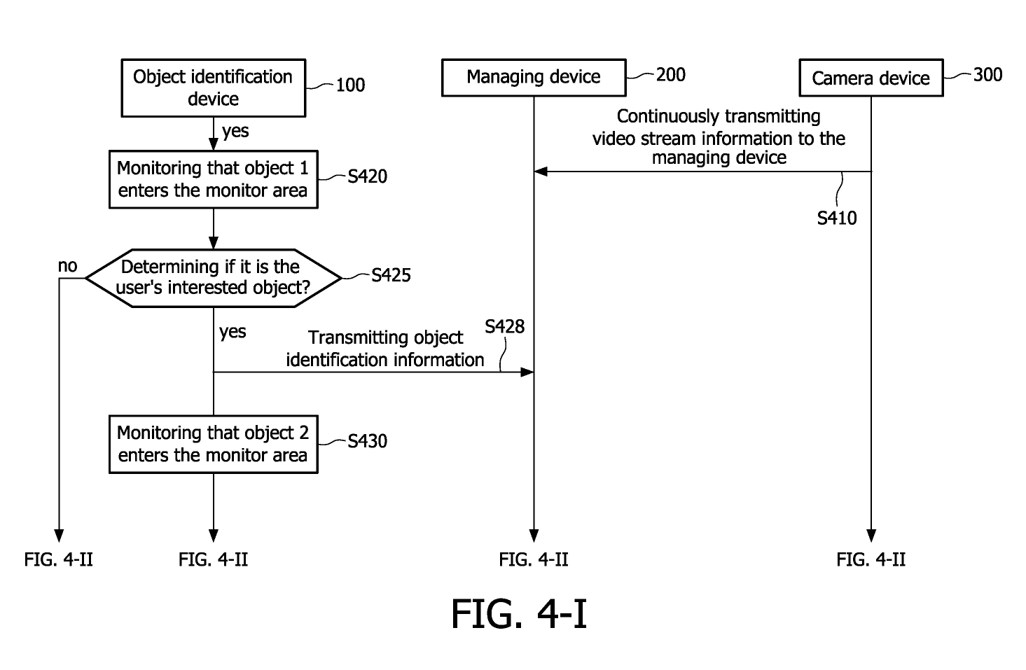

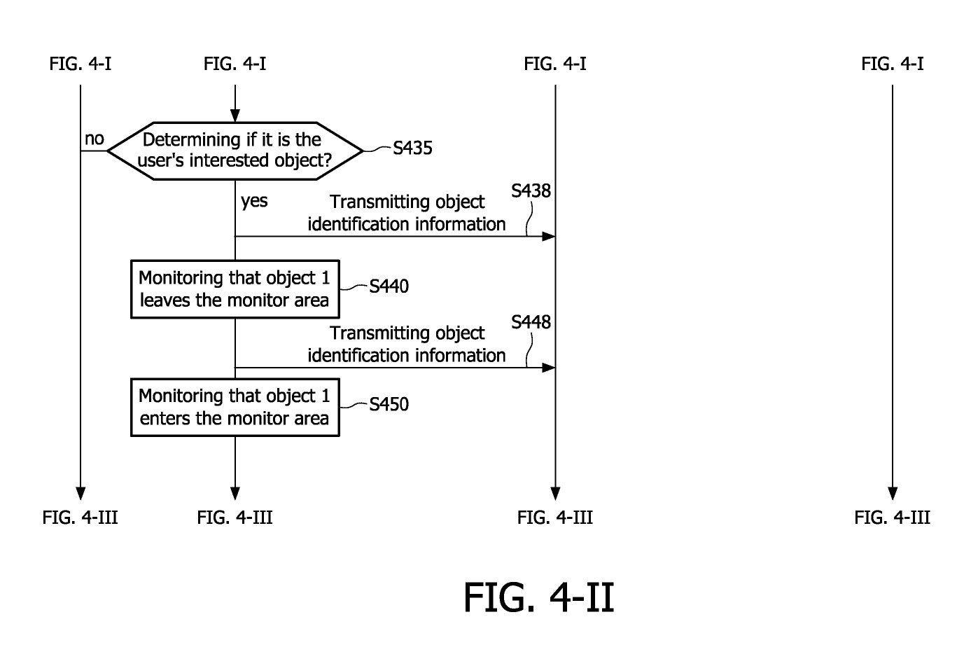

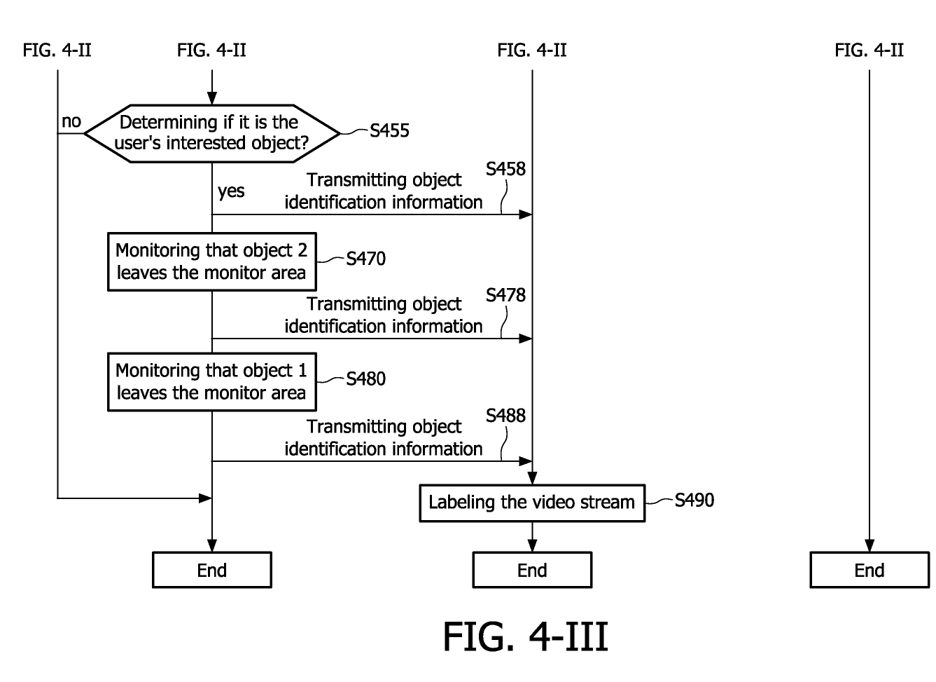

FIG. 4 is the flow chart of the management method of the video surveillance system according to one embodiment of the present invention.

First, in step S410, the camera device 300 continuously transmits the video stream obtained by shooting to the managing device 200, so that the managing device 200 can store the corresponding video stream according to the identification information of the objects.

Next, in step S420, the object identification device 100 detects that object 1 has entered the identifiable area. For example, by means of RFID technology, the object identification device 100 transmits radio frequency signals of a certain frequency through the antenna (not shown), when an object 1 (person or object) having a RFID tag enters the identifiable range of the RFID reader, i.e., it enters the magnetic field range of the radio frequency signal transmitted by the RFID reader, the RFID tag generates induction current to obtain energy to send object identification information like code of itself to be read by the label reading device 110, such as ID number, so as to confirm the identity of said object, then the object identification device 100 can determine that object 1 has entered the identifiable area.

Afterwards, in step S425, the object identification device 100 determines whether said object is the one in which the user is interested. The object identification device 100 compares the received object identification information to a pre-set object identification information list, wherein said object identification information list is pre-set by the user to indicate the objects that the user wants to monitor. If said object identification information is in said object identification information list, it indicates that the user is interested in said monitored object.

If it has been determined that said object is the user's interested object, in step 428, the object identification device 100 transmits the identification information of said object to the managing device 200, so that the managing device 200 could label the corresponding video streams according to the identification information of said object to record a start time information to the playlist of an object 1, such as 15:23:48 (step S490).

According to one embodiment of the present invention, the managing device 200 will generate a playlist for each object, said playlist includes one or a plurality of play intervals for indicating the time period in which each object appears in the video stream.

According to another embodiment of the present invention, there could also be at least one optional step, that is, the object identification device 100 transmits an awakening information to the camera device 300 to awaken it to begin to work. While when the user needs to monitor the surveillance scenes of all the periods of time, and needs to particularly monitor the scenes of the periods of time when a specific person or object appears, said camera device will be in the working state all the time and does not need any awakening.

In step S430, the object identification device 100 detects that object 2 enters the identifiable area. The detailed process is similar to that of step S420 and it will not be elaborated any more.

Then, in step S435, the object identification device 100 determines if said object is the user's interested object, and the detailed process is similar to that of step S425, so it will not be elaborated herein.

If it is determined that said object 2 is the user's interested object, then in step 438, the object identification device 100 transmits the identification information of said object 2 to the managing device 200, so that the managing device 200 could label the corresponding video stream according to the identification information of said object to record a beginning time information to the playlist of object 2, such as 15:30:28 (step S490).

In step S440, the object identification device 100 detects that object 1 leaves the identifiable area, then by using, for example, the RFID technology, the object identification device 100 transmits radio frequency signals of a certain frequency through antenna (not shown in the figure), and no object identification information transmitted from object 1, like the coding of itself, is received, it could be determined that object 1 has left the identifiable area.

In step S448, the object identification device 100 transmits the identification information of said object 1 to the managing device 200, so that the managing device 200 could label the corresponding video stream according to the identification information of said object to record end time information to the playlist of an object 1, such as 15:45:29 (step S490).

Then, object 1 re-enters the identifiable area. The subsequent corresponding steps S450, S455 and S458 are similar to the above-described step S420, S425 and S428, so they will not be elaborate herein. The managing device 200 labels the corresponding video stream according to the identification information of said object 1, and again records start time information to the playlist of an object 1, such as 16:01:29 (step S490).

Subsequently, in steps S470 and S480, the object identification device 100 detects that object 2 and object 1 leave the identifiable area in turn, then in steps S478 and S488, the object identification device 100 transmits the identification information of object 2 and object 1 to the managing device 200 respectively, so that the managing device 200 could label the corresponding video stream according to the identification information of said object to record an end time information to the playlist of an object 2, such as 16:15:21; and record an end time information to the playlist of an object 1, such as 17:05:27 (step S490).

Finally, according to the above flow, the user could obtain the playlist of a part, such as object 1 and object 2 as shown in FIG. 3.

According to another embodiment of the present invention, there could be at least one optional step, that is, the object identification device 100 detects whether all the user's interested objects have left the identifiable area (i.e., the area that could be monitored). If it is determined that all the user's interested objects have left, the object identification device 100 can transmit a dormancy information to the camera device 300 to make the camera device 300 enter the dormant state, thus to save electrical energy and the corresponding video storage resources. The camera device 300 enters the dormant state after receiving said dormancy information until it receives awakening information.

Those skilled in the art should understand that the object-based method and apparatus for storing real-time information as disclosed in the present invention can be improved in various ways without deviating from the contents of the present invention, so the protection scope of the invention should be defined by the attached claims.

1. An object-based real-time information management method, including the steps of
(a) obtaining an identification information of an object, said identification information including identity information of said object and the relevant information of an event of said object;
(b) receiving a real-time information, said real time information being associated with said event of said object; and
(c) labeling said real-time information according to said identification information.

2. The method according to claim 1, wherein said real-time information is a video stream.

3. The method according to claim 1, wherein the relevant information of said event at least includes one of the start time and end time of said event.

4. The method according to claim 1, further including the steps of
(d) obtaining an identification information of another object, said identification information including the identity information of said another object and the relevant information of an event of said another object, said event of said another object being associated with said real-time information;
(e) labeling said real-time information according to the identification information of said another object.

5. The method according to claim 1, further including the steps of
(f) obtaining another identification information of an object, said identification information including the identity information of said object and the relevant information of another event of said object, said another event of said object being associated with said real-time information;
(g) labeling said real-time information according to said another identification information.

6. An object-based real-time information management apparatus, comprising:
an object identification information receiving device for obtaining an identification information of an object, said identification information including identity information of said object and the relevant information of an event of said object;
a real-time information receiving device for receiving a real-time information, said real time information being associated with said event of said object; and
a labeling device for labeling said real-time information according to said identification information.

7. The apparatus according to claim 6, wherein said real-time information is a video stream.

8. The apparatus according to claim 6, wherein the relevant information of said event at least includes one of the start time and end time of said event.

9. The apparatus according to claim 6, wherein said object identification information receiving device is also used for obtaining an identification information of another object, said identification information including the identity information of said another object and the relevant information of an event of said another object, said event of said another object being associated with said real-time information; and said labeling device is used for labeling said real-time information according to the identification information of said another object.

10. The apparatus according to claim 6, wherein said object identification information receiving device is further used for obtaining another identification information of an object, said identification information including identity information of said object and the relevant information of another event of said object; said another event of said object is associated with said real-time information; and said labeling device is used for labeling said real-time information according said another identification information.
